(19) United States
(12) Patent Application Publication
(10) Pub. No.: US 2014/0134961 A1
(43) Pub. Date: May 15, 2014

(54) Common Local Oscillator For Multiple Transceivers

(71) Applicant: NOKIA SIEMENS NETWORKS OY, Espoo (FI)

(72) Inventor: Russell Morris, Keller, TX (US)

(73) Assignee: Nokia Siemens Networks Oy, Espoo (FI)

(21) Appl. No.: 13/673,268

(22) Filed: Nov. 9, 2012

(51) Int. Cl. H04B 1/40

(52) U.S. Cl. CPC H04B 1/403
USPC 455/76

(57) ABSTRACT

The specification and drawings present a new apparatus and method for using a common local oscillator for multiple transceivers (e.g., in a BST unit). One or two shared local oscillators LOs/frequency sources in a wireless transceiver may be configured to generate corresponding one or more oscillator signals, so that the corresponding portions of the one or two oscillator signals generated by the one or two LOs may be provided to multiple transmitters and to multiple receivers through corresponding paths in the wireless transceiver. For example it may be a shared use of frequency sources/LOs between multiple pipes/branches of the BST (one local oscillator for all transmitters, and another local oscillator for all receivers in the multiple pipes/branches). The implementation may require proper routing, and amplification and/or frequency conversion if necessary, of the shared LO signals.

### TECHNICAL FIELD

The exemplary and non-limiting embodiments of this invention relate generally to wireless communications, and more specifically to using a common local oscillator for multiple transceivers (e.g., in a base station transceiver unit).

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

3GPP third generation partnership project

BB baseband

BS base station

BST base station transceiver

BW bandwidth

CDMA code divisional multiple access

CMOS complimentary metal-oxide semiconductor

DL downlink

E-UTRA evolved universal terrestrial radio access

eNB evolved node B/base station in an E-UTRAN system

LO local oscillator

LTE long term evolution

LTE-A long term evolution advanced

PCB printed circuit board

RF radio frequency

RFM radio frequency module

Rx receiver, receive

SWCR software change request

Tx transmitter, transmit

UE user equipment

UL uplink

UTRAN universal terrestrial radio access network

A cellular base station transceiver (BST) may typically contain multiple transmit (Tx) and receive (Rx) paths, and each path may contain its own frequency sources (local oscillators) to allow up and down conversion of RF signals (to and from the RF band of interest, relative to baseband signal processing). For example, the base station radio may comprise N radio pipes/branches (N being a finite integer of more than one) which can convert corresponding radio frequency signals provided to/from antennas from/to baseband signals. Each pipe/branch may comprise a pair of a transmitter and a receiver and a pair of local oscillators (LOs), where one LO provides an oscillator signal to the transmitter of the pair and another LO provides an oscillator signal to the receiver of the pair (the first and second oscillator signals may have the same or different frequencies in general).

This is illustrated in FIG. 1 showing an example of a BST 10 for N=3 with respective three pipes/branches 14-1, 14-2 and 14-3 which receive/send baseband signals from/to a baseband/signal processing unit 12. Each pipe/branch has a corresponding transmitter and receiver pair and two local oscillators 16-1 and 16-2 for providing oscillator signals to the transmitter and receiver respectively. The local oscillator signals from the local oscillators 16-1 and 16-2 are provided via paths 17 and 18 to the corresponding transmitters and receivers in each pipe/branch.

### SUMMARY

According to a first aspect of the invention, a method, comprising: generating in a wireless radio device one or more oscillator signals by one or two local oscillators; providing in the wireless radio device corresponding portions of the one or two oscillator signals generated by the one or two local oscillators to multiple transmitters and to multiple receivers through corresponding paths in the wireless radio device.

According to a first aspect of the invention, an apparatus, comprising: one or two local oscillators configured to generate corresponding one or more oscillator signals; multiple transmitters and multiple receivers; and multiple paths through which the one or two local oscillators are configured to send corresponding portions of the one or two oscillator signals to the multiple transmitters and to the multiple receivers.

### BRIEF DESCRIPTION OF THE DRAWINGS

For a better understanding of the nature and objects of the present invention, reference is made to the following detailed description taken in conjunction with the following drawings, in which:

FIG. 1 is an example of a block diagram of relevant portions of a conventional base station transceiver;

FIG. 2 is an example of a block diagram of a wireless transceiver with two shared local oscillators, according to an exemplary embodiment of the invention;

FIG. 3 is an example of a block diagram of a wireless transceiver with two shared local oscillators and amplifiers, according to an exemplary embodiment of the invention;

FIG. 4 is an example of a block diagram of a wireless transceiver with one shared local oscillator and amplifier and frequency converters/shifters, according to an exemplary embodiment of the invention;

FIG. 5 is a flow chart demonstrating implementation of exemplary embodiments of the invention.

### DETAILED DESCRIPTION

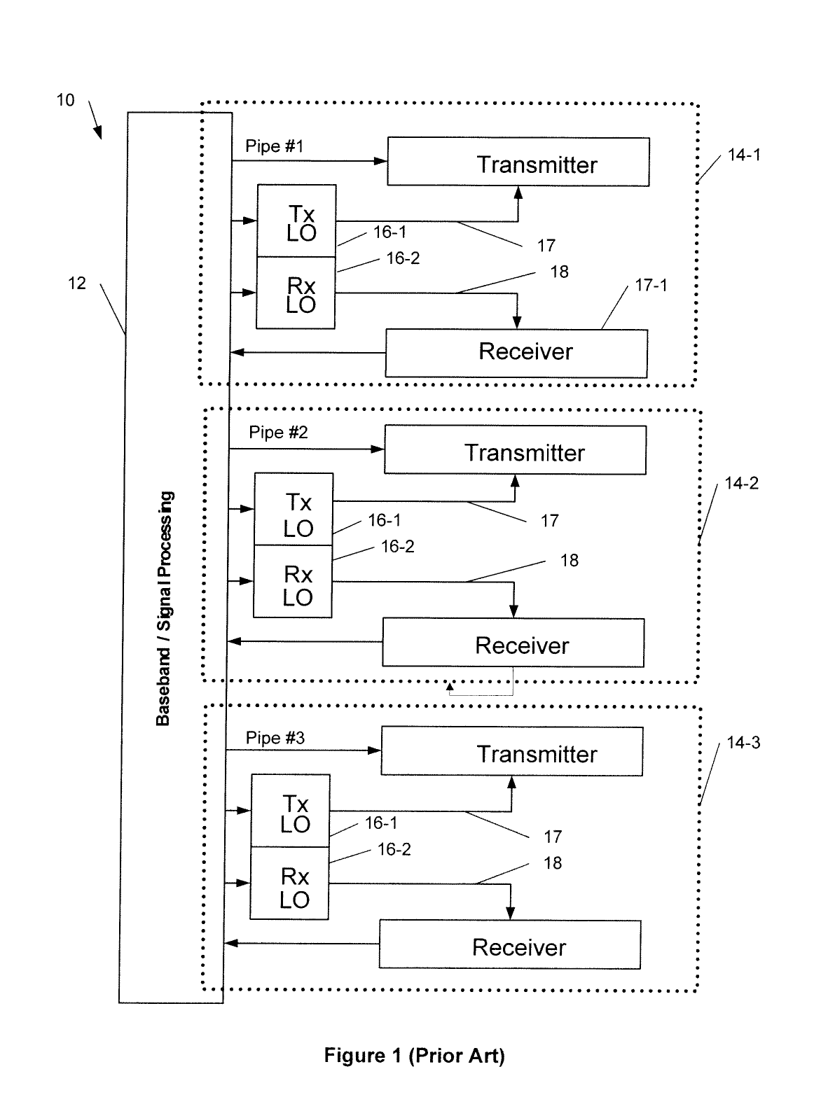

As noted herein, in a conventional approach typically a frequency source/local oscillator (LO) can be used for each pipe/branch in the BST. Such an approach shown in FIG. 1 above is not cost and size optimized, especially if the RF bands of the pipes/branches 14-1, 14-2 and 14-3 inside the BST 10 are common (which typically occurs if each pipe/branch supports full bandwidth operation).

A new method and apparatus are presented for using a common local oscillator for multiple transceivers (e.g., in a base station transceiver unit). According to embodiments of the invention one or two shared LOs/frequency sources in a wireless radio device (e.g., transceiver) may be configured to generate corresponding one or more oscillator signals, so that the corresponding portions of the one or two oscillator signals generated by the one or two LOs may be provided to multiple transmitters and to multiple receivers through corresponding paths in the wireless radio device. For example it may be a shared use of frequency sources/LOs between multiple pipes/branches of the BST (one local oscillator for all transmitters, and another local oscillator for all receivers in the multiple pipes/branches). The implementation of the embodiments described herein may require proper routing, and amplification and/or frequency conversion/shifting if necessary, of the shared LO signals as further described herein. It is noted that for the purposes of this invention the term “pipe” is equivalent to the term “branch”.

The wireless radio device may be a BST or a wireless transceiver comprised in an access node/network element such as eNB and the like in LTE/LTE-A systems or even in a UE such as a mobile phone, a camera mobile phone, a wireless video phone, a portable device or a wireless computer, etc. The key advantages in this new shared approach may be space savings on a PCB, and cost savings of removed/unnecessary components.

According to one embodiment, the wireless radio device (transceiver) may comprise two shared LOs each generating one oscillator signal, where the portions of the first generated oscillator signal are provided to the multiple receivers (e.g., in multiple pipes) and the portions of the second generated oscillator signal are provided to the multiple transmitters (in these multiple pipes). The two oscillator signals generated by the two LOs (one oscillator signal for transmitters and another oscillator signal for receivers) in general may have different frequencies (but also may have a same frequency) based on specific applications. Proper routing the portions of the one or two oscillator signals may be implemented using one or more radio frequency (microwave) signal splitters. Also, as stated herein, all or selected corresponding portions of oscillator signals may be amplified in the corresponding paths.

Moreover, in a wireless radio device multiple transmitters and multiple receivers may be parts of multiple pipes (e.g., see FIG. 1), wherein each pipe comprises one transmitter and one receiver. Alternatively, it can be unequal number of transmitters and receivers in one pipe/branch. For example, it can be at least one transmitter and two or more receivers (i.e., two or more receive paths) in one pipe to provide better reception for low level signals (e.g., for a 3 pipe radio device it can be 3 transmitters and 6 receivers). According to one embodiment, each pipe may represent a sector of space covered by corresponding one or more antenna of the wireless radio device. For example, the wireless radio device (transceiver) can comprise three pipes, so that each pipe may represent a sector of space (e.g., 120°) covered by the corresponding one or more antenna of the wireless radio device (transceiver). Also each pipe may support a same radio frequency band, e.g., 35 MHz BW between 925 and 960 MHz.

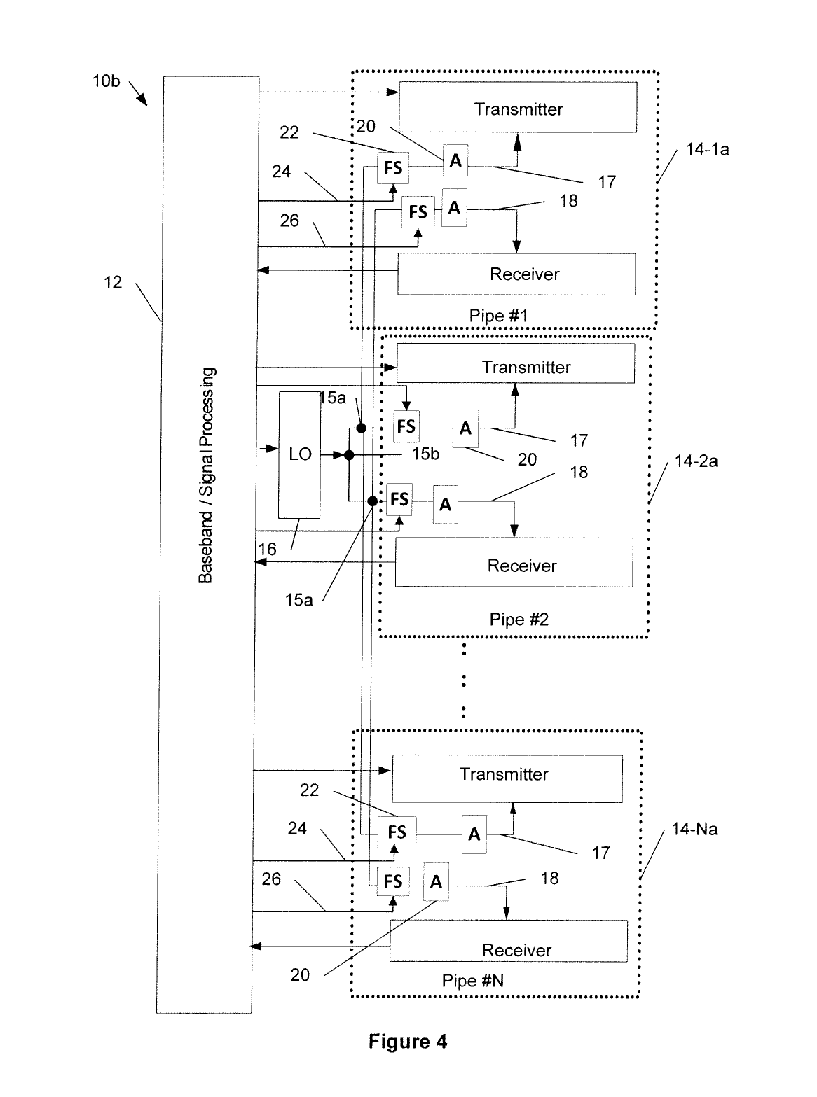

According to a further embodiment, the wireless radio device (transceiver) with multiple pipes may have only one LO generating one oscillator signal to provide corresponding portions of this one generated oscillator signal to both the multiple receivers and to the multiple transmitters in the multiple pipes (see an example shown in FIG. 4). In this embodiment, if necessary, at least selected corresponding portions of the oscillator signal in the corresponding paths may be frequency converted/shifted (or may not be, depending on the design architecture).

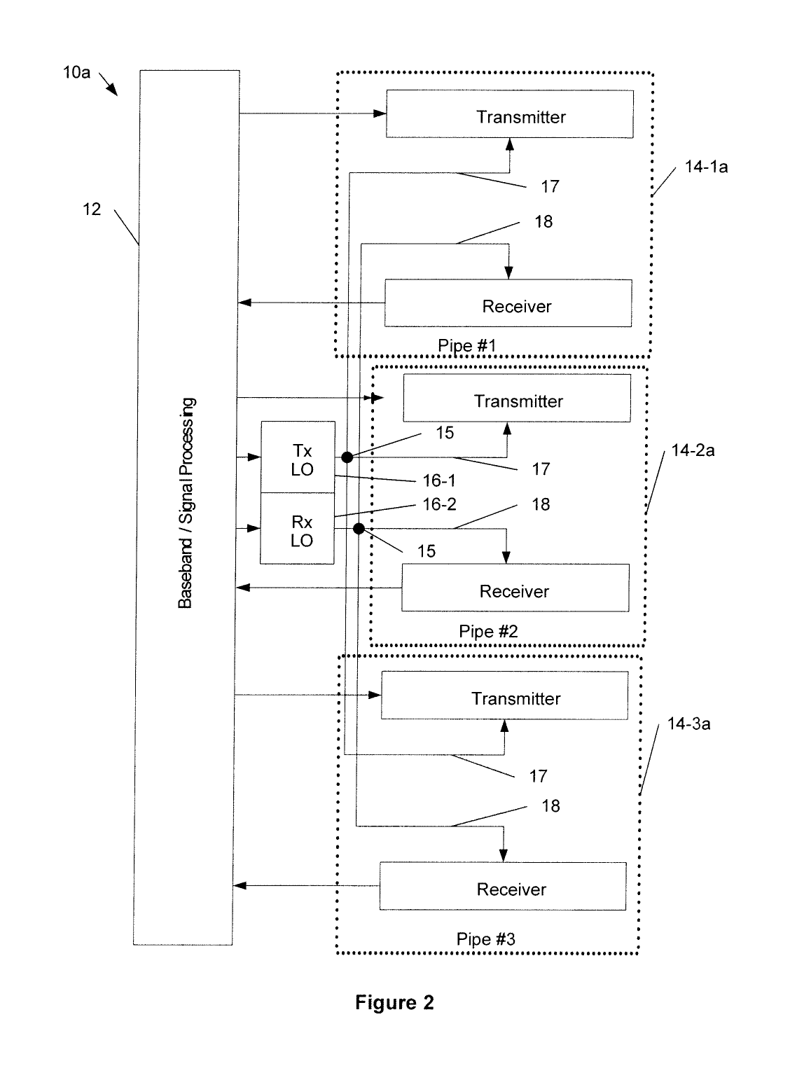

FIGS. 2-4 shows examples demonstrating exemplary embodiments described herein.

FIG. 2 demonstrates an exemplary embodiment of a BST 10a with three pipes 14-1a, 14-2a and 14-3a which receive/send baseband signals from/to a baseband/signal processing unit 12. The pipes 14-1a, 14-2a and 14-3a may have the same (or possibly different) radio signal BW. Each pipe has a corresponding one transmitter and one receiver which can use different oscillator frequencies from different LOs. However, the difference with the example shown in FIG. 1 is that there is only one pair of LOs 16-1 and 16-2 shared by the three pipes 14-1a, 14-2a and 14-3a. Each oscillator signal (from the LO 16-1 or 16-2) is split into 3 portions by an element 15 such as 1×3 radio frequency signal splitter and provided via paths 17 and 18 to the corresponding transmitters and receivers in each pipe.

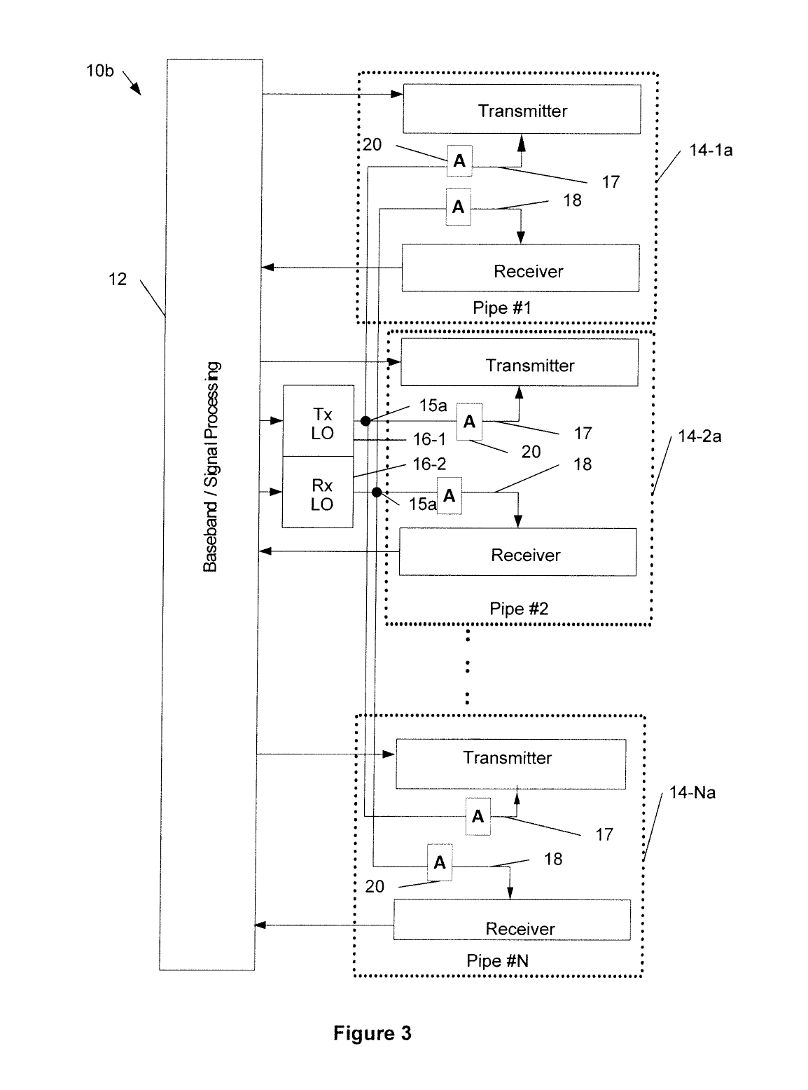

FIG. 3 demonstrates another exemplary embodiment of a BST 10b with N pipes 14-1a, 14-2a, . . . , 14-Na (N is a finite integer of two or more) which receive/send baseband signals from/to a baseband/signal processing unit 12. The pipes 14-1a, 14-2a, . . . , 14-Na may have the same (or possibly different) radio signal BW. Each pipe has a corresponding one transmitter and one receiver which can use different oscillator frequencies from different LOs (as in FIG. 2). Also in FIG. 3 there is only one pair of LOs 16-1 and 16-2 shared by the N pipes 14-1a, 14-2a, . . . , 14-Na. Each oscillator signal (from the LO 16-1 or 16-2) is split into N portions by an element 15a such as 1×N radio frequency signal splitter and provided via paths 17 and 18 to the corresponding transmitters and receivers in each pipe. In addition, in each pipe each path for the oscillator signals towards transmitter and receivers may have an optional amplifier 20 for adjusting/amplifying the amplitude of the portions of the oscillator signal (if necessary). In order to minimize signal interference, in one embodiment the amplifiers may be placed at a source end (e.g., closer to the LO 16-1 or 16-2), or the amplifiers may be placed at a termination end (e.g., closer to the transmitter or receiver).

FIG. 4 demonstrates a further exemplary embodiment of a BST 10c with N pipes 14-1a, 14-2a, . . . , 14-Na (N is a finite integer of two or more) which receive/send baseband signals from/to a baseband/signal processing unit 12. The pipes 14-1a, 14-2a, . . . , 14-Na may have the same (or possibly different) radio signal BW. Each pipe has a corresponding one transmitter and one receiver which can use the same or different oscillator frequencies as in FIGS. 2 and 3. However, in FIG. 4 only one LO 16 is shared by the N pipes 14-1a, 14-2a, . . . , 14-Na. In particular, the oscillator signal from the LO 16 is split into two portions by an element 15b such as 1×2 radio frequency signal splitter and each splitted signal is further divided into N portions by the element 15a such as 1×N radio frequency signal splitter and provided via paths 17 and 18 to the corresponding transmitters and receivers in each pipe as shown in FIG. 4. Alternatively, one 1×2N radio frequency signal splitter can be used instead of splitters 15a and 15b. Also, each path for the portions of the oscillator signal towards transmitter and receivers in each pipe may have an optional amplifier to adjust/amplify the amplitude of the corresponding portions of the oscillator signal. In addition, each path for the oscillator signals towards transmitter and receivers in each pipe may have an optional frequency converter/shifter to have flexibility for the oscillator frequencies to be used by the transmitters and receivers in different pipes. It is noted that frequency converting/shifting can be also used, if necessary in the examples shown in FIGS. 2 and 3.

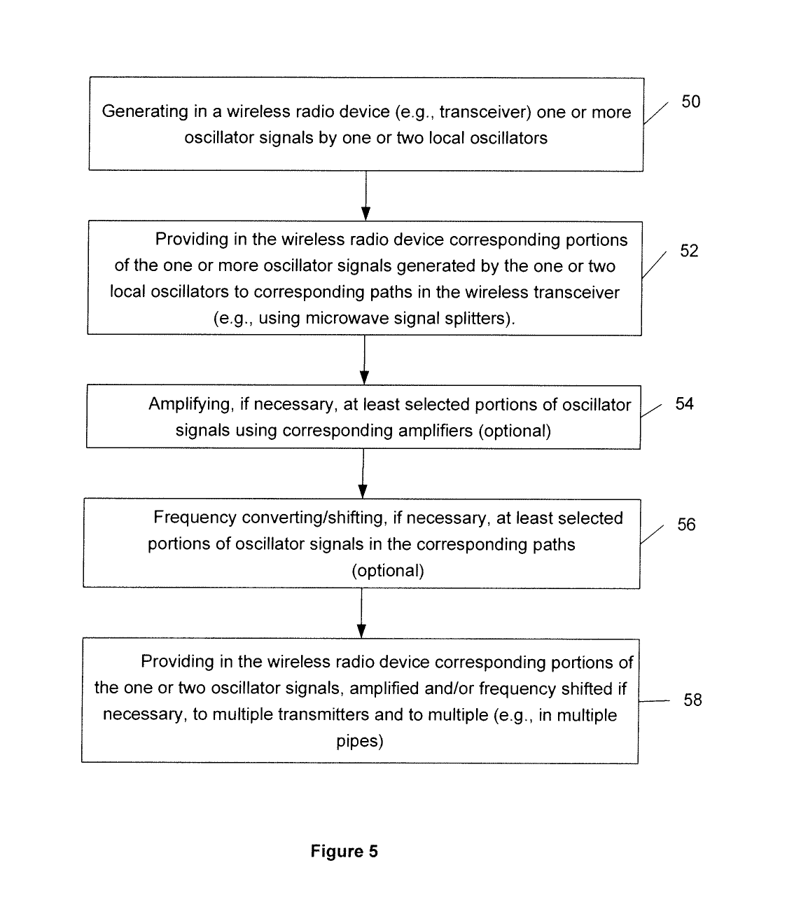

FIG. 5 shows a flow chart demonstrating implementation of the exemplary embodiments of the invention. It is noted that the order of steps shown in FIG. 5 is not absolutely required, so in principle, the various steps may be performed out of the illustrated order. Also certain steps may be skipped, different steps may be added or substituted, or selected steps or groups of steps may be performed in a separate application following the embodiments described herein.

In a method according to this exemplary embodiment, as shown in FIG. 5, in a first step 50, in a wireless radio device (e.g., transceiver) one or two local oscillators generate one or more oscillator signals. In a next step 52, providing in the wireless radio device corresponding portions of the one or more oscillator signals generated by the one or two local oscillators to corresponding paths in the wireless radio device (e.g., using radio frequency/microwave signal splitters).

In a next step 54, amplifying in the wireless radio device, if necessary, at least selected portions of oscillator signals in the corresponding paths using corresponding amplifiers (optional step). In a next step 56, frequency converting/shifting in the wireless radio device, if necessary, at least selected portions of oscillator signals in the corresponding paths using corresponding frequency converters (optional step).

In a next step 58, providing in the wireless radio device corresponding portions of the one or two oscillator signals, amplified and/or frequency shifted if necessary, to multiple transmitters and to multiple receivers (e.g., in multiple pipes).

It is noted that various non-limiting embodiments described herein may be used separately, combined or selectively combined for specific applications.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the present invention. Numerous modifications and alternative arrangements may be devised by those skilled in the art without departing from the scope of the invention, and the appended claims are intended to cover such modifications and arrangements.

What is claimed is:

1. A method, comprising:
generating in a wireless radio device one or more oscillator signals by one or two local oscillators;
providing in the wireless radio device corresponding portions of the one or two oscillator signals generated by the one or two local oscillators to multiple transmitters and to multiple receivers through corresponding paths in the wireless radio device.

2. The method of claim 1, where the one or two local oscillators comprise two local oscillators each generating one oscillator signal, where the portions of a first generated oscillator signal are provided only to the multiple receivers and the portions of a second generated oscillator signal are provided only to the multiple transmitters.

3. The method of claim 2, wherein the two oscillator signals generated by the two local oscillators have different frequencies.

4. The method of claim 1, wherein the providing of the corresponding portions of the one or two oscillator signals comprises:
amplifying at least selected portions of oscillator signals in the corresponding paths.

5. The method of claim 1, where multiple transmitters and multiple receivers are parts of multiple pipes, wherein each pipe comprises at least one transmitter and one or more receivers.

6. The method of claim 5, wherein each pipe represents a sector of space covered by corresponding one or more antenna of the wireless radio device.

7. The method of claim 6, wherein the multiple pipes comprise three pipes and each pipe represents a sector of space of 120 degrees covered by the corresponding one or more antenna of the wireless radio device.

8. The method of claim 5, wherein a same radio frequency bandwidth is supported by each pipe.

9. The method of claim 1, wherein the providing of the corresponding portions of the one or two oscillator signals comprises:
frequency converting at least selected portions of oscillator signals in the corresponding paths.

10. The method of claim 1, where the one or two local oscillators comprise one local oscillator generating one oscillator signal, where portions of the one generated oscillator signal are provided in the wireless radio device to both the multiple receivers and to the multiple transmitters.

11. The method of claim 1, wherein the portions of the one or two oscillator signals are routed in the wireless radio device using one or more radio frequency signal splitters.

12. An apparatus, comprising:
one or two local oscillators configured to generate corresponding one or more oscillator signals;
multiple transmitters and multiple receivers; and
multiple paths through which the one or two local oscillators are configured to send corresponding portions of the one or two oscillator signals to the multiple transmitters and to the multiple receivers.

13. The apparatus of claim 12, where the one or two local oscillators comprise two local oscillators each generating one oscillator signal, where the portions of a first generated oscillator signal are provided only to the multiple receivers and the portions of a second generated oscillator signal are provided only to the multiple transmitters.

14. The apparatus of claim 13, wherein the two oscillator signals generated by the two local oscillators have different frequencies.

15. The apparatus of claim 12, further comprising:
amplifiers configured to amplify at least selected corresponding portions of oscillator signals in the corresponding paths.

16. The apparatus of claim 12, where multiple transmitters and multiple receivers are parts of multiple pipes in the apparatus, wherein each pipe comprises at least one transmitter and one or more receivers.

17. The apparatus of claim 16, wherein each pipe represents a sector of space covered by corresponding one or more antenna of the wireless radio device.

18. The apparatus of claim 17, wherein the multiple pipes comprise three pipes and each pipe represents a sector of space of 120 degrees covered by the corresponding one or more antenna.

19. The apparatus of claim 16, wherein a same radio frequency bandwidth is supported by each pipe.

20. The apparatus of claim 12, further comprising:
frequency converters configured to frequency shift/convert at least selected portions of oscillator signals in the corresponding paths.

21. The apparatus of claim 1, where the one or two local oscillators comprise one local oscillator generating one oscillator signal, where the wireless radio device is configured to provide portions of the one generated oscillator signal to both the multiple receivers and to the multiple transmitters.

22. The apparatus of claim 12, further comprising:
radio frequency signal splitters configured to route of the portions of the one or two oscillator signals.

23. The apparatus of claim 12, where the apparatus comprises a base station transceiver.
